(19) United States
(12) Patent Application Publication
(10) Pub. No.: US 2007/0115527 A1
(43) Pub. Date: May 24, 2007

(54) Light deflecting apparatus

(75) Inventor: Sang-hoon Lee, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/541,747

(22) Filed: Oct. 3, 2006

(30) Foreign Application Priority Data
Nov. 22, 2005 (KR) 2005-112040

(51) Int. Cl. G02B 26/08

(52) U.S. Cl. 359/200

(57) ABSTRACT

A light deflecting apparatus is employed in a light scanning unit of an image forming device. Such a deflecting apparatus includes a stator having a sleeve disposed at a printed circuit board (PCB), and a core disposed around the sleeve, to which coils are wound; a rotor having a rotor frame connected to an axis which is rotatably supported in the sleeve, and a rotor housing fixed to the rotor frame to surround the core; and a polygon mirror supported on the rotor frame. At least one of the rotor frame and the rotor housing is formed of a plastic material. Because the rotor frame and/or the rotor housing is formed of the plastic material, the high precision manufacture of such a light deflecting apparatus which requires mechanical machining and press working, is not needed. As a result, the manufacture of such a light deflecting apparatus is made simpler and easier; and, likewise, a working time and an exhaustion of manpower are reduced, so that a manufacturing cost is reduced. In addition, an unbalance of weight at the rotor frame and/or the rotor housing, which is influenced by a working precision thereof, is minimized, so that the light deflecting apparatus may maintain a stable performance.

### CROSS-REFERENCE TO RELATED APPLICATIONS

This application claims all benefits accruing under 35 U.S.C. §119 from Korean Patent Application No. 2005-112040, filed on Nov. 22, 2005, in the Korean Intellectual Property Office, the content of which is incorporated herein by reference.

### BACKGROUND OF THE INVENTION

1. Field of the Invention

The present invention relates to an image forming device, and more particularly, relates to a light deflecting apparatus adapted to be used in a light scanning unit of an image forming device, such as a printer, a copier, a facsimile machine or a multi-functional product.

2. Related Art

In general, an image forming device, such as a printer, a copier, a facsimile machine or a multi-functional product, is provided with a light scanning unit such as a laser scanning unit to form an electrostatic latent image on a photoconductive body such as a photoconductive drum. The light scanning unit has a light deflecting apparatus such as a polygon motor arranged to deflect a light such as a laser beam radiated from a light source such as a laser diode to a scanning lens with a certain angle of image, thereby to form the electrostatic latent image on a photoconductive body.

FIG. 1 shows an example of a general light deflecting apparatus provided in an image forming device. As shown in FIG. 1, the light deflecting apparatus 10 is provided with a sleeve 3, an axis 2, a core 4, and a rotor frame 5. The sleeve 3 is installed at a printed circuit board (PCB) 1. The axis 2 is supported in the sleeve 3 by a bearing 3a. The core 4 in which coils 4a are wound is disposed around the sleeve 3. The rotor frame 5 is fixed to a top end of the axis 2 to mount a rotary polygon mirror 7 thereon.

At a under surface of the rotor frame 5 is disposed a rotor housing 6 configured to surround the core 4, and at an inner surface of the rotor housing 6 is disposed a magnet 6a that generates a magnetic force. The magnetic force of the magnet 6a produces a torque for rotating the rotor housing 6 in cooperation with an electromagnetic force of the coils 4a.

Further, at an upper side of the rotor frame 5 on which the rotary polygon mirror 7 is mounted is installed a fixing spring 8 to immovably support the rotary polygon mirror 7.

In the conventional light deflecting apparatus 10 constructed as shown in FIG. 1, the most important component that has influence on a performance of the light deflecting apparatus 10, that is, a light scanning performance, is the rotary polygon mirror 7. Accordingly, to enhance the performance of the light deflecting apparatus 10, a stable support of the rotary polygon mirror 7 together with a precise manufacturing of such the rotary polygon mirror 7 are essential.

To stably support the rotary polygon mirror 7, the rotor frame 5 which supports the rotary polygon mirror 7 must be manufactured in a high precision. In addition, the rotor housing 6 which has influence on the rotation of the rotary polygon mirror 7 must also be manufactured to have a minimum unbalance of weight.

However, the rotor frame 5 is usually manufactured by machining a cylindrical body formed of metal such as aluminum or brass. As a result, material waste is large and the manufacturing process can be difficult, so that a manufacturing cost is increased.

In addition, the rotor housing 6 is usually manufactured by pressing a disc formed of metal such as stainless steel. As a result, a high level of precision of a press working technique to manufacture the rotor housing 6 having a proper balance of weight, is required.

Moreover, at the inner surface of the rotor housing 6 is fixed the magnet 6a formed of a compound in which rubber, plastic or rare earth, and magnetic material are mixed. As a result, a high level of precision is required to fix the magnet 6a to the inner surface of the rotor housing 6 to avoid generating the unbalance of weight and an assembly deviation between the magnet 6a and the rotor housing 6.

Furthermore, the rotor housing 6 is usually fixed to the rotor frame 5 by a caulking process. However, such a caulking process does not uniformly fix the rotor housing 6 to the rotor frame 5 in a circumferential direction due to its working characteristic, so that the rotor housing 6 may not have a proper balance of weight after fixed to the rotor frame 5. In this case, the light deflecting apparatus 10 may not stably scan a light on the photoconductive body due to the unbalance of weight at the rotor housing 6 during an initial operation, thereby deteriorating a quality in electrostatic latent image that is formed on the photoconductive body by the light deflecting apparatus 10.

### SUMMARY OF THE INVENTION

Several aspects and example embodiments of the present invention provide a light deflecting apparatus in which a rotor frame and/or a rotor housing is formed of a plastic material, thereby facilitating a manufacturing, reducing a manufacturing cost, and maintaining a stable performance.

Additional aspects and/or advantages of the invention will be set forth in part in the description which follows and, in part, will be obvious from the description, or may be learned by practice of the invention.

In accordance with an aspect of the present invention, a light deflecting apparatus is provided with a rotor housing and a magnet attached thereto are integrally formed by a single part of a plastic material, thereby facilitating a manufacture, reducing a manufacturing cost, and maintaining a stable performance.

In accordance with an embodiment of the present invention, a light deflecting apparatus comprises a stator having a sleeve disposed at a printed circuit board (PCB), and a core disposed around the sleeve, to which coils are wound; a rotor having a rotor frame connected to an axis which is rotatably supported in the sleeve, and a rotor housing fixed to the rotor frame to surround the core; and a polygon mirror supported on the rotor frame. At least one of the rotor frame and the rotor housing is formed of a plastic material.

According to an aspect of the present invention, the plastic material may be selected from a group consisting of polyamide, polyester, polycarbonate, polybutylene terephthalate (PBT), and polyphenylene oxide (PPO). The housing may further be formed of a magnetic material, and such a magnetic material may be composed of a ferrite power. In this case, the rotor housing may have a magnetized part disposed opposite to the core in which the magnetic material formed therein is magnetized to have a plurality of magnetic polarities.

According to an aspect of the present invention, the rotor frame and the rotor housing may be fixed with each other by an ultrasonic fusing. In this case, the rotor housing may have at least one fusing projection, and the rotor frame may have at least one projection receiving groove to receive the fusing projection.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a sectional view illustrating a general light deflection apparatus;

FIG. 2 is a sectional view illustrating a light deflection apparatus in accordance with an embodiment of the present invention; and

FIG. 3 is a sectional view illustrating example rotor of the light deflection apparatus illustrated in FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 is a view schematically illustrating an example light deflection apparatus 100 according to an embodiment of the present invention. As shown in FIG. 2, the light deflection apparatus 100 comprises a printed circuit board (PCB) 101, a stator 110, a rotor 120, and a rotary polygon mirror 107.

The printed circuit board (PCB) 101 has a light source (not shown) such as a laser diode forming a light scanning unit (not shown) such as a laser scanning unit, and all sorts of circuit chips (not shown) for driving the light source, which are mounted thereon.

The stator 110 is provided with a sleeve 103 and a core 104. The sleeve 103 is disposed at the printed circuit board (PCB) 101. The core 104 is installed around the sleeve 103. At an inside surface of an upper portion of the sleeve 101 is installed a washer 103b to prevent oil leakage, i.e., oil from being dispersed from a bearing 103a. At the core 104 is formed a plurality of slots, for example, 9 slots (not shown), each to which a coil 104a is wound to generate an electromagnetic force of corresponding magnetic polarity when applied thereto with an electric current.

The rotor 120 includes an axis 102 and a rotor frame 105. The axis 102 is rotatably in the sleeve 103 by the bearing 103a. The rotor frame 105 is fixed to a top end of the axis 102 to hold the rotary polygon mirror 107.

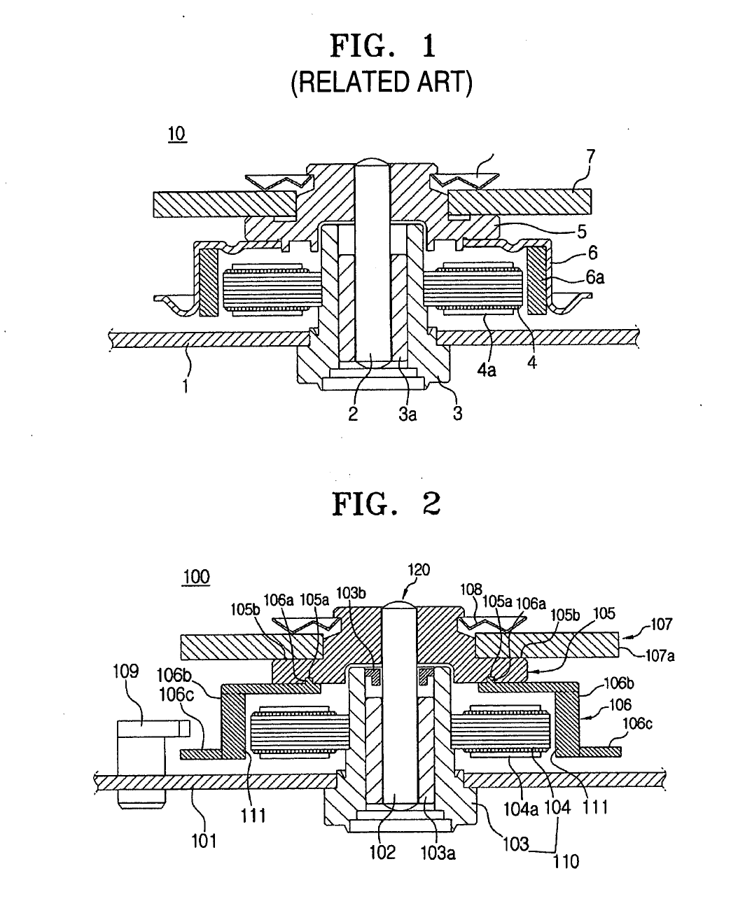

The rotor frame 105 is formed by injection-molding an engineering plastic material, such as polyamide, polyester, polycarbonate, polybutylene terephthalate (PBT), or polyphenylene oxide (PPO), which has a good thermal resistance and a good impact-resisting property. Accordingly, the rotor frame 105 can be uniformly manufactured without a loss in time, manpower and materials. Such a motor frame 105 can also be generated according to mechanically machining a metal cylindrical body in a high precision as in the rotor frame 5 of the conventional light deflecting apparatus 10, as shown in FIG. 1, so that a manufacture cost can be reduced. In addition, because a weight of the rotor frame 105 is reduced, an initial starting time, which takes until the rotor 120 reaches a normal speed, can be reduced compared with the conventional light deflecting apparatus 10, as shown in FIG. 1.

At an under surface of the rotor frame 105 is fixed a rotor housing 106 which is configured to surround the core 104.

The rotor housing 106 is formed by injection-molding a magnetic material, such as a ferrite powder and an engineering plastic material, such as polyamide, polyester, polycarbonate, polybutylene terephthalate (PBT), or polyphenylene oxide (PPO), which has a good thermal resistance and a good impact-resisting property. Accordingly, during manufacturing, there is little possibility to produce a poor rotor having an unbalance of weight that is influenced by the precision of the press working for a metal disc as in the rotor housing 6 of the conventional light deflecting apparatus 10, as shown in FIG. 1. Thus, an amount in the unbalance of weight which is caused by the rotor housing 106 to result in an unstable scanning of light during an initial operation of the light deflecting apparatus 100 is greatly reduced, and thereby a performance of the light deflecting apparatus 100 is enhanced. In addition, because a weight of the rotor housing 106 is reduced, an initial starting time, which takes until the rotor 120 reaches a normal speed, can be reduced compared with the conventional light deflecting apparatus 10, as shown in FIG. 1.

At a lower portion 106b of the rotor housing 106 is formed a magnetized part 111, which generates a magnetic force. The magnetic force of the magnetized part 111 produces a torque for rotating the rotor 120 in cooperation with the electromagnetic force of the coils 104a.

The magnetized part 111 is composed of a plurality of magnetic portions, for example, 6 magnetic portions, which are circumferentially formed opposite to the core 104 at the lower portion 106b of the rotor housing 106. The 6 magnetic portions are disposed to alternate N polarities with S polarities. Positions of such magnetic polarities are identical to those of the magnet 6a of the conventional light deflecting apparatus 10, as shown in FIG. 1, or the magnet known in the art, detailed descriptions thereof will be omitted for the sake of brevity.

The magnetized part 111 is magnetized in the 6 magnetic portions by a magnetizing process using a known magnetizing device (not shown) before or after the rotor housing 106 is fixed to the rotor frame 105 by an ultrasonic fusing which will be described later.

A stopper 109 is disposed above a side of an outer end 106c of the lower portion 106b of the rotor housing 106. The stopper 109 is fixed on the printed circuit board (PBC) 101 to prevent the rotor 120 detachably installed to the stator 110 from being separated from the stator 110 when an impact from the outside is imparted on the rotor 120.

The rotor frame 105 and the rotor housing 106 are fixed with each other by the ultrasonic fusing process using an ultrasonic fusing device (not shown). To assist the ultrasonic fusing between the rotor frame 105 and the rotor housing 106, the rotor housing 106 has at least one fusing projection 106a, and the rotor frame 105 has at least one projection receiving groove 105a to receive the fusing projection 106a.

Hereinafter, the ultrasonic fusing process of fixing the rotor housing 106 to the rotor frame 105 according to an embodiment of the present invention will now be described herein below.

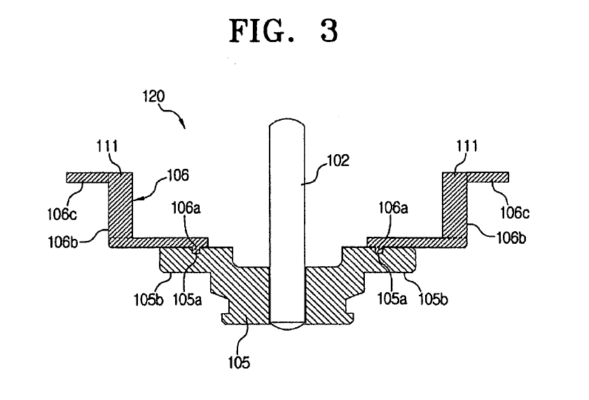

First, as illustrated in FIG. 3, the rotor frame 105 is placed on a bed (not shown) of the ultrasonic fusing device.

Subsequently, the rotor housing 106 is placed on the rotor frame 105, so that the fusing projection 106a is inserted into the projection receiving groove 105a.

Under this state, a jig (not shown) attached to the ultrasonic fusing device is decent onto portions of the rotor housing 106 and the rotor frame 105, between which adjoin each other in the vicinity of the fusing projection 106a and the projection receiving groove 105a. Then, the ultrasonic fusing device applies a vibration energy converted from an ultrasonic energy in range of 15-20 Khz on the adjoining portions of the rotor housing 106 and the rotor frame 105 through the jig for a predetermined time.

As a result, the adjoining portions of the rotor housing 106 and the rotor frame 105 generate a friction heat in a moment due to the powerful vibration energy, so that the fusing projection 106a and the projection receiving groove 105a are fused and fixed with each other.

The rotary polygon mirror 107 is mounted on an upper surface 105c of the rotor frame 105. After the rotor frame 105 is injection-molded, the upper surface 105c of the rotor frame 105 is preferably polished through a grinding treatment and the like to have a required assembly precision, so that it is precisely joined with the rotary polygon mirror 107 during assembling.

The rotary polygon mirror 107 is formed in, for example, a hexagon shape having six reflective surfaces 107a, so that a light radiated from the light source reflects to a scanning lens of the light scanning unit with a certain angle of image when it is rotated by the rotor 120. However, such a rotary polygon mirror 107 may be formed in different shapes and having different reflective surfaces to reflect a light from the light source to the scanning lens of the light scanning unit.

At an upper side of the rotor frame 105 on which the rotary polygon mirror 107 is mounted is installed a fixing spring 108 to immovably hold the rotary polygon mirror 107.

Hereinafter, an operation of the light deflecting apparatus 100 according to an embodiment of the present invention constructed as shown in FIG. 2, will now be described in detail.

At first, when the coils 104a are supplied with an electric current, the coils 104a generate an electromagnetic force, and the electromagnetic force of the coils 104a produce a torque for rotating the rotor housing 106 in cooperation with a magnetic force of the magnetized part 111. As a result, the rotor housing 106 is rotated at a high speed.

As the rotor housing 106 is rotated at a high speed, the rotor frame 105 joined with the rotor housing 106 and the rotary polygon mirror 107 fixed on the rotor frame 105 are rotated at a high speed together with the rotor housing 106.

While the rotary polygon mirror 107 is rotated, a light radiated to the rotary polygon mirror 107 from the light source is reflected to the scanning lens of the light scanning unit with a certain angle of image by the reflective surfaces 107a.

The light reflected to the scanning lens is again reflected by a reflective mirror (not shown) of the light scanning unit, and scanned onto a photoconductive body (not shown) of an image forming device. As a result, an electric potential is lowered at a portion of a surface of the photoconductive body on which the light is scanned, so that an electrostatic latent image is formed on the surface of the photoconductive body.

According to the present invention as described above, the light deflecting apparatus 100 has the rotor frame and/or the rotor housing formed of a plastic material. So, when the light deflecting apparatus 100 is manufactured, an operation of requiring a high precision such as a mechanical machining and a press working is not needed. As a result, the manufacture of such a light deflecting apparatus is simpler and easier; and, likewise, a working time and an exhaustion of manpower are reduced, so that a manufacturing cost is reduced. Moreover, an unbalance of weight at the rotor frame and/or the rotor housing, which is influenced by a working precision thereof, is minimized, so that the light deflecting apparatus may maintain a stable performance. Also, because a weight of the rotor comprising the rotor frame and the rotor housing is reduced, an initial starting time, which takes until the rotor reaches a normal speed, can be reduced compared with the conventional light deflecting apparatus, as shown in FIG. 1.

Further, according to an embodiment of the present invention as shown in FIG. 2 and FIG. 3, the light deflecting apparatus has a rotor housing and a magnet attached thereto integrally formed by a single part of a plastic material including a magnetic material therein. So, precisely manufacturing a rotor housing and a magnet to allow the magnet to be assembled to the rotor housing without generating an assembly deviation therebetween, as well as assembling the magnet to the rotor housing, is not needed. Accordingly, a manufacturing comes to be easy, and a manufacturing cost is reduced. Also, an unbalance of weight at the rotor housing, which can be caused as a result of assembling the magnet to the rotor housing, is not produced. Thus, an amount in the unbalance of weight, which results in an unstable scanning of light during an initial operation of the light deflecting apparatus, is greatly reduced, and thereby a performance of the light deflecting apparatus is enhanced.

The foregoing embodiment and advantages are merely exemplary and are not to be construed as limiting the present invention. The present teaching can be readily applied to other types of apparatuses. Also, the description of the embodiment of the present invention is intended to be illustrative, and not to limit the scope of the claims, and many alternatives, modifications, and variations will be apparent to those skilled in the art.

While the light deflecting apparatus of the present invention has been particularly shown and described with reference to exemplary embodiments thereof, it will be understood by those of ordinary skill in the art that various changes in form and details may be made therein without departing from the spirit and scope of the present invention. For example, components of a light scanning unit (LSU) can be arranged differently. In addition, other light sources can also be provided. Moreover, the operating part and the light deflecting mirror can be constructed differently as long as the rotor frame and/or the rotor housing, as wel as the rotor housing and the magnet attached thereto are formed in the manner as described with reference to FIG. 2 to FIG. 3. Accordingly, it is intended, therefore, that the present invention not be limited to the various example embodiments disclosed, but that the present invention includes all embodiments falling within the scope of the appended claims.

What is claimed is:

1. A light deflecting apparatus comprising:
a stator having a sleeve disposed at a printed circuit board, and a core disposed around the sleeve, to which coils are wound;
a rotor having a rotor frame connected to an axis which is rotatably supported in the sleeve, and a rotor housing fixed to the rotor frame to surround the core; and
a polygon mirror supported on the rotor frame,
wherein at least one of the rotor frame and the rotor housing is formed of a plastic material.

2. The light deflecting apparatus as claimed in claim 1, wherein the plastic material is one selected from a group consisting of polyamide, polyester, polycarbonate, polybutylene terephthalate (PBT), and polyphenylene oxide (PPO).

3. The light deflecting apparatus as claimed in claim 1, wherein the rotor housing is further formed of a magnetic material.

4. The light deflecting apparatus as claimed in claim 3, wherein the magnetic material comprises a ferrite powder.

5. The light deflecting apparatus as claimed in claim 3, wherein the rotor housing comprises a magnetized part disposed opposite to the core, in which the magnetic material formed therein is magnetized to have a plurality of magnetic polarities.

6. The light deflecting apparatus as claimed in claim 1, wherein the rotor frame and the rotor housing are fixed with each other by an ultrasonic fusing.

7. The light deflecting apparatus as claimed in claim 6, wherein the rotor housing comprises at least one fusing projection, and the rotor frame comprises at least one projection receiving groove to receive the fusing projection.

8. The light deflecting apparatus as claimed in claim 1, wherein the core is formed of a plurality of slots each of which a coil is wound to generate an electromagnetic force of a corresponding magnetic polarity when applied thereto with an electric current.

9. The light deflecting apparatus as claimed in claim 1, wherein the rotor frame is formed by injection molding a plastic material selected from a group consisting of polyamide, polycarbonate, polybutylene terephthalate (PBT), and polyphenylene oxide (PPO).

10. The light deflecting apparatus as claimed in claim 1, wherein the rotor frame is formed by injection molding a ferrite powder and a plastic material selected from a group consisting of polyamide, polycarbonate, polybutylene terephthalate (PBT), and polyphenylene oxide (PPO).

11. The light deflecting apparatus as claimed in claim 1, further comprising a stopper fixed on the printed circuit board to secure the rotor relative to the stator.

12. An image forming apparatus comprising:
a photoconductive member;
a light scanning unit arranged to deflect a light irradiated from a light source to form an electrostatic latent image on the photoconductive member; and
a light deflecting apparatus provided inside the light scanning unit to deflect the light irradiated from the light source, the light deflecting apparatus comprising a stator having a sleeve disposed at a printed circuit board, and a core disposed around the sleeve, to which coils are wound; and a rotor having a rotor frame connected to an axis which is rotatably supported in the sleeve, and a rotor housing fixed to the rotor frame to surround the core; wherein at least one of the rotor frame and the rotor housing is formed of a plastic material.

13. The image forming apparatus as claimed in claim 12, wherein the plastic material is one selected from a group consisting of polyamide, polyester, polycarbonate, polybutylene terephthalate (PBT), and polyphenylene oxide (PPO).

14. The image forming apparatus as claimed in claim 12, wherein the rotor housing is further formed of a magnetic material.

15. The image forming apparatus as claimed in claim 14, wherein the magnetic material comprises a ferrite powder.

16. The image forming apparatus as claimed in claim 14, wherein the rotor housing comprises a magnetized part disposed opposite to the core, in which the magnetic material formed therein is magnetized to have a plurality of magnetic polarities.

17. The image forming apparatus as claimed in claim 12, wherein the rotor frame and the rotor housing are fixed with each other by an ultrasonic fusing.

18. The image forming apparatus as claimed in claim 12, wherein the rotor housing comprises at least one fusing projection, and the rotor frame comprises at least one projection receiving groove to receive the fusing projection.

19. The image forming apparatus as claimed in claim 12, wherein the core is formed of a plurality of slots each of which a coil is wound to generate an electromagnetic force of a corresponding magnetic polarity when applied thereto with an electric current.

20. The image forming apparatus as claimed in claim 12, wherein the rotor frame is formed by injection molding a ferrite powder and a plastic material selected from a group consisting of polyamide, polycarbonate, polybutylene terephthalate (PBT), and polyphenylene oxide (PPO).
